(19) United States
(12) Patent Application Publication
(10) Pub. No.: US 2012/0082815 A1
(43) Pub. Date: Apr. 5, 2012

(54) Healthcare Form Assembly Having a Plurality of Removable Strips with Adhesive Free Feature

(75) Inventors: Anne M. DEHLINGER, North Tonawanda, NY (US); Michael J. MOORE, Amelia Island, FL (US); William BECKER, Lockport, NY (US)

(73) Assignee: AVERY DENNISON CORPORATION, Pasadena, CA (US)

(21) Appl. No.: 13/021,873

(22) Filed: Feb. 7, 2011

Related U.S. Application Data
(60) Provisional application No. 61/302,593, filed on Feb. 9, 2010.

(51) Int. Cl. B32B 7/06; B41M 5/00

(52) U.S. Cl. 428/41.8

(57) ABSTRACT

A healthcare treatment form assembly suitable for use in a patient treatment theater for use in securing treatment appliances to an individual. The form assembly includes a laminated, pressure sensitive assembly having a plurality of uniquely sized strips that can be easily removed and applied by the care giver.

### CROSS-REFERENCE TO RELATED APPLICATION

The present application claims the benefit of U.S. Provisional Application No. 61/302,593 filed Feb. 9, 2010, which is incorporated herein by reference in its entirety.

### FIELD OF THE INVENTION

The present invention relates to a business communication carrier for use in providing a number of removable pre-cut strips for used in the healthcare field.

### BACKGROUND OF THE INVENTION

The treatment of individuals in various healthcare related environments typically requires the use of a wide variety of medical devices, appliances, pharmaceuticals and other treatments. In order to reduce the possible spread of disease or contamination of the surgical or treatment theaters, typically, devices are not reused and must be disposed of once the patient or individual has been treated.

Certain treatment devices, such as IV bags, oxygen and nutritional supply tubes, catheters, monitoring device feed lines and the like require that the apparatus be removably attached to the patient or the individual. Commonly, a piece of tape, which is often supplied from a roll, is torn from the supply and then applied to the tube, line or the like to secure the tube to the patient. In an effort to further reduce possible contamination, the remaining portion of the roll of tape is typically discarded leading to additional waste and cost in the care facility. When multiple sizes are required to hold or secure different appliances to the patient, then different sized rolls of tape are needed, which of course are discarded after exposure to the treatment theater and must be discarded, leading to additional waste and expense.

In addition, removal of the piece of tape by a healthcare provider can also be difficult, particularly if the provider is wearing surgical gloves as the leading edge of the tape cannot be easily or readily grasped by the hand or fingers of the provider due to the nature of the latex glove that the provider may be wearing.

What is needed therefore is an inexpensive delivery system by which a plurality of removable strips can be delivered to a treatment theater which can be easily removed and applied when needed.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a healthcare treatment form assembly that is suitable for use in a patient treatment theater to secure treatment appliances to an individual. The form assembly includes a laminated, pressure sensitive assembly having a plurality of uniquely sized strips that can be easily removed and applied to the patient by the care giver.

In one exemplary embodiment of the presently described invention, a healthcare form assembly is presented and includes a quadrate carrier sheet having first and second transversely extending edges and first and second longitudinally extending sides. The quadrate sheet has top and bottom surfaces.

A release coating is applied substantially over the top surface of the quadrate carrier sheet and a pattern of adhesive is applied over the release coating on the top surface of the quadrate sheet to create at least first and second adhesive areas that have a top edge and a bottom edge. First and second peel zones are provided along at least the top edge of each of the first and second adhesive areas.

Continuing with a discussion of the presently described embodiment, a quadrate printable sheet is juxtaposed substantially entirely over the quadrate carrier sheet. The quadrate printable sheet is provided with a plurality of cut lines running substantially parallel to the first and second longitudinally extending sides of the quadrate carrier sheet to form a series of removable strips over each of the first and second adhesive area.

A plurality of transversely extending cut lines extends substantially parallel to the transversely extending edges of the quadrate carrier sheet. A first set of transversely extending cut lines that defines the first peel zone along the top edge of the first adhesive area and a second set of transversely extending cut lines that defines the second peel zone along the top edge of the second adhesive area.

In a further exemplary embodiment of the presently described invention, a pressure sensitive laminate assembly for use in securing medical appliances is described and includes a first sheet that has top and bottom faces, first and second ends and first and second sides. A release coating is applied over the top face of the first sheet and a pattern of pressure sensitive adhesive is applied over the release coating on top face of the first sheet.

Continuing with a description of the presently described embodiment, a second sheet is applied over the pattern of pressure sensitive adhesive. The second sheet is provided with a plurality of longitudinally extending cuts and a series of transversely extending cuts running substantially perpendicular to the longitudinally extending cuts. The plurality of longitudinally extending cuts defines a series of first and second removable strips having at least first and second dimensions. The first dimension has a first width and length and the second dimension has a second width less than the first width and a length.

The series of transversely extending cuts defines first and second adhesive free areas, with the first adhesive free area defining a leading edge of a first area of strips and the second adhesive free area defining a leading edge of a second area of strips and the first and second areas of strips are substantially equal in area.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the healthcare form assembly of the presently described invention;

FIG. 1A illustrates an alternate configuration in which a central zone is provided with a plurality of finger lift peel zones;

FIG. 2 provides a cross sectional elevation of the healthcare form assembly of the presently described invention;

FIG. 3 shows the peel area of the pressure sensitive laminate form assembly; and

FIG. 4 illustrates an exemplary use of the healthcare form assembly of the presently described invention.

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods for physiological monitoring of a biological organism using electrical measurements are hereinafter disclosed and described in detail with reference made to FIGURES.

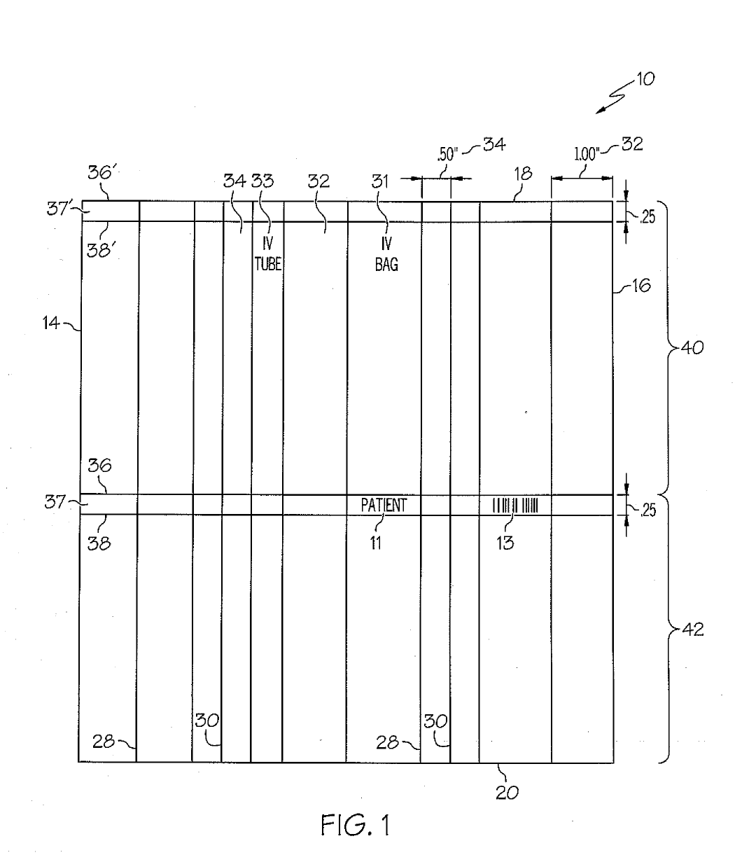

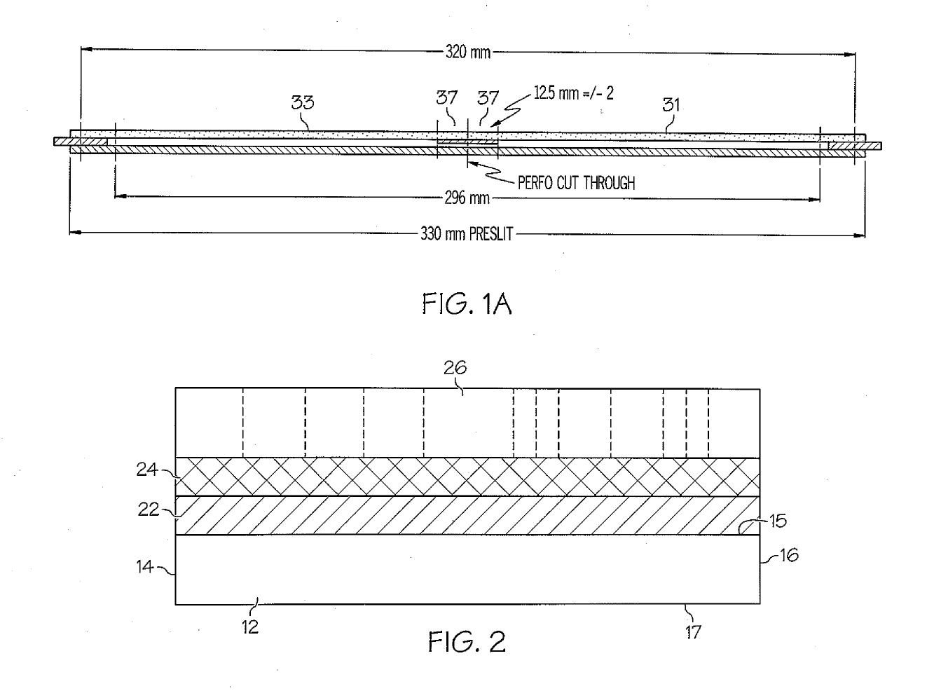

Reference is now directed to FIG. 1 in which a healthcare form assembly is generally depicted by reference to numeral 10. The form includes a quadrate sheet 12 that has first and second longitudinally extending sides 14, 16 and first and second transversely extending end edges 18, 20. The quadrate sheet 12 has top and bottom surfaces 15, 17, see FIG. 2. A release coating 22 is applied over the top surface 15 of the quadrate sheet 12. The release coating 22 is preferably a silicone based coating. A pattern of pressure sensitive adhesive 24 is applied over the release coating 22. A quadrate printable sheet 26 is applied over the adhesive 24.

Pressure sensitive adhesives suitable for use with the present invention include permanent, removable, repositionable or other adhesives or combinations thereof that may meet the particular need of the end use application. For example, a removable adhesive may be used to secure a section of medical tubing to a patient's arm such as with an intravenous (IV) tube. It should be understood that the assembly can be provided with a single type of adhesive, or alternatively, different types of adhesive can be applied to the form in order to serve different functions. For example, certain removable strips (which will be described herein) can be provided with a permanent adhesive and other types of removable strips can be provided with a removable adhesive.

The printable sheet 26 is provided with a plurality of longitudinally extending cut lines 28, 30 which run parallel to the first and second longitudinally extending sides 14 and 16. The cut lines 28, 30 section or divide the sheet into individual removable strips 32, 34, which release from the assembly with adhesive on the back side of the strips. The strips have a length and a width, with the length of the strips 32, 34 being substantially equal and the width of the strips being different. For example, the length of the strips may be 5.25″ in length and the width of strip 32 is about one inch (1.00″), while the width of the strip 34 is about one half of an inch (0.50″).

The printable or top sheet 26 is also provided with a plurality of transversely extending cut lines 36, 38 and 36′, 38′ (see FIG. 1) which run perpendicular to the first and second longitudinally extending sides 14, 16 and parallel to the first and second ends 18, 20. The transversely extending cut lines 36, 38 divide the sheet 26 into first and second areas 40, 42 which are substantially equal. The space between the transversely extending cut lines 36, 38 and 36′, 38′ is about 0.25″. The space between the transversely extending cut lines 36, 38 and 36′, 38′ creates peel zones 37, 37′ which facilitate the removal of the strips 32, 34 from the assembly 10.

The printable sheet 26 can be coated selectively with a print binder material such as polyvinyl alcohol to help the toner or ink adhere to the surface of the sheet. In addition, the entire assembly can be coated or provided with an antimicrobial material to reduce potential contamination.

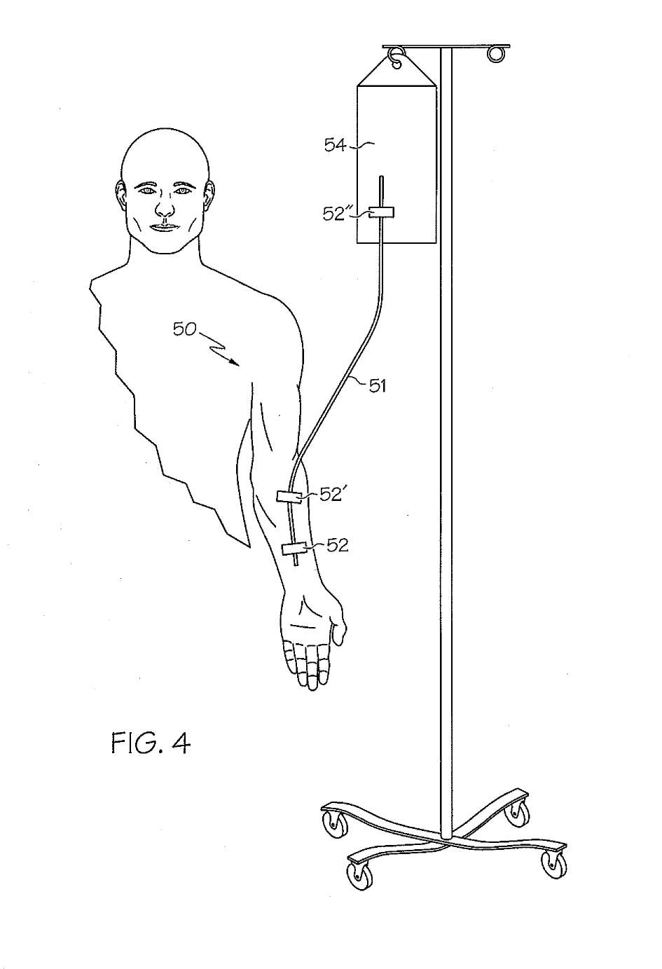

The printable sheet 26 may be provided with indicia 33, 31 to assist the care provider in selecting the appropriate strips for use in treating the patient. For example, strip 31 may be used to attach a tube (see FIG. 4) to an IV bag whereas strip 33 may be used to attach an IV tube to a patient's arm. Other information can be provided on the sheet 26, such as patient indicia and bar codes 11 and 13 respectively, or other hospital information.

The peel zones 37, 37′, or finger lift regions, are either areas that are free of adhesive, that is during the pattern coating of the adhesive 24, no adhesive is provided in the areas of the peel zones, creating an adhesive free area of approximately 0.25″ wide by 8.5″ long. In another embodiment the zones have a bottom dimension of 10 mm and a top dimension of 12 mm. Alternatively, if adhesive is provided, it is deadened, such as by corona treating so that the adhesive does not create any tension when removing the strips 32, 34. The first peel zone 37′ creates the leading edge of the first area 40 while the second peel zone 37 creates the leading edge of the second area 42.

The finger lift areas 37 and 37′ have a perforated cut through one edge to enable easy separation of the finger lift region from the form itself.

In one embodiment, the finger lift strip is about 10 mm, and the removable strip 31, 33 has a dimension of about 160 mm and a final tape dimension of 148 mm (160 mm with the 12 mm finger lift strip removed). The strip has a width of about 24 mm. For convenience in the alternate configuration shown in FIG. 1A, similar reference numerals are used.

In another embodiment as shown in FIG. 1A where the form is provided with plural removable strips, the length of the form is about 320 mm with a central finger lift area of about 25 mm, which is separated into two parts of about 12 mm each. In this way, the strips can be removed in an opposite direction. In this fashion instead of the finger lifts being at each end, the finger lifts are centrally disposed and thus by bending the finger lift areas can be exposed to remove the parts from the form.

Each of the first and second areas 40 and 42 will have an equal number of strips 32, 34 which are similarly dimensioned, that is, the strips will all have a length of 5.25″ and widths of 0.50″ and 1.00″.

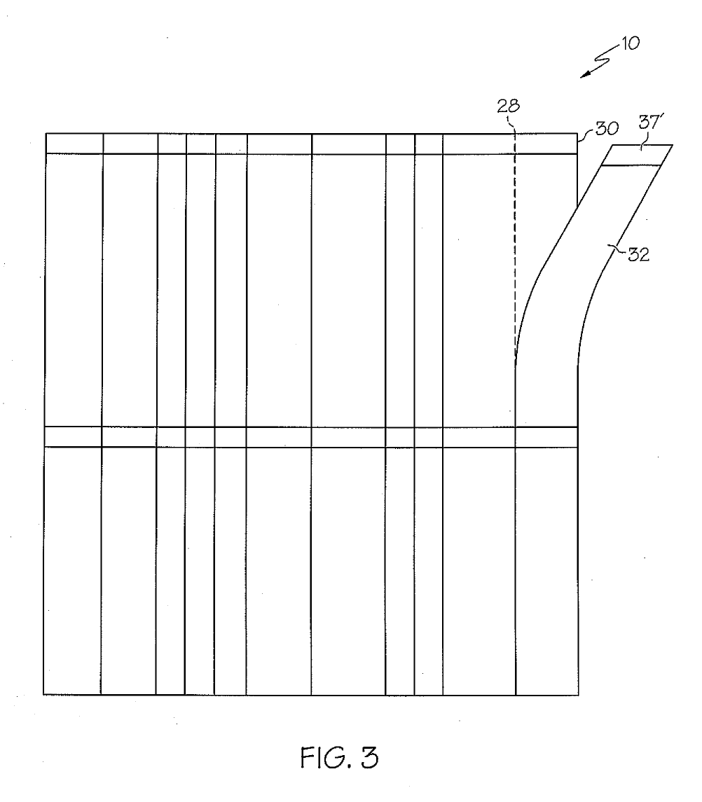

Attention is now directed to FIG. 3 in which the healthcare form assembly 10 which illustrates the peeling away of one removable strip 32 through use of the peel tab 37′. The peel tab 37′ pulls away from the remainder of the peel zone by uses of the longitudinally extending cut lines 28, 30 which define the individual strips.

Reference is now directed to FIG. 4 which shows an exemplary method of using the presently described invention. FIG. 4 provides a cut away of a patients arm 50 to which a intravenous feed tube 51 has been connected. Removable strips 52, 52′ have been applied to the arm 50 to secure the tube 51 to the patient. In this example, the strips 52 and 52′ may be provided with removable or repositionable adhesive so that the strips may be readily removed from the patient at the end of the treatment or when changing IV bags. Strip 52″ secures the tube 51 to the IV bag 54, which may be for example accomplished through the use of a permanent adhesive so that the tube 51 does not separate from the bag 54.

It will thus be seen according to the present invention a highly advantageous healthcare assembly has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. A healthcare form assembly, comprising;
a quadrate carrier sheet, the quadrate carrier sheet having first and second transversely extending edges and first and second longitudinally extending sides, the quadrate sheet having top and bottom surfaces;
a release coating applied substantially over the top surface of the quadrate carrier sheet;
a pattern of adhesive applied over the release coating on the top surface of the quadrate sheet to create at least first and second adhesive areas having a top edge and a bottom edge;
first and second peel zones provided along at least the top edge of each of the first and second adhesive areas;
a quadrate printable sheet juxtaposed substantially entirely over the quadrate carrier sheet, the quadrate printable sheet is provided with a plurality of cut lines running substantially parallel to the first and second longitudinally extending sides of the quadrate carrier sheet to form a series of removable strips over each of the first and second adhesive area; and
a plurality of transversely extending cut lines extending substantially parallel to the transversely extending edges of the quadrate carrier sheet, a first set of transversely extending cut lines defining the first peel zone along the top edge of the first adhesive area and a second set of transversely extending cut lines defining the second peel zone along the top edge of the second adhesive area.

2. A healthcare form assembly as recited in claim 1, wherein the quadrate carrier sheet has dimensions of about 8½″ by 11″.

3. A healthcare form assembly as recited in claim 1, wherein the series of removable strips over each of the first and second adhesive zones have a substantially equal length.

4. A healthcare form assembly as recited in claim 1, wherein the series of removable strips over each of the first and second adhesive zones include strips having at least two different widths.

5. A healthcare form assembly as recited in claim 4, wherein one of the two different widths is about 1″.

6. A healthcare form assembly as recited in claim 4, wherein one of the two different widths is about 0.5″.

7. A healthcare form assembly as recited in claim 1, wherein each of the adhesive peel zones is about 0.25″ wide.

8. A healthcare form assembly as recited in claim 3, wherein the length of the removable strips is about 5.25″.

9. A healthcare form assembly as recited in claim 1, wherein each of the series of removable strips have a greater length than a width.

10. A healthcare form assembly as recited in claim 1, wherein the series of removable strips include strips having first and second dimensions that are distinct from one another.

11. A healthcare form assembly as recited in claim 1, wherein the peel zones are provided with a tab to facilitate removal of each of the series of removable strips.

12. A healthcare form assembly as recited in claim 1, wherein each of the peel zones have dimensions of about 0.25″ wide by 8.5″.

13. A pressure sensitive laminate assembly for use in securing medical appliances, comprising;
a first sheet having top and bottom faces, first and second end and first and second sides;
a release coating applied over the top face of the first sheet;
a pattern of pressure sensitive adhesive applied over the release coating on top face of the first sheet;
a second sheet applied over the pattern of pressure sensitive adhesive, the second sheet is provided with a plurality of longitudinally extending cuts and a series of transversely extending cuts running substantially perpendicular to the longitudinally extending cuts;
the plurality of longitudinally extending cuts defining a series of first and second removable strips having at least first and second dimensions, the first dimension having a first width and length and the second dimension having a second width less than the first width and a length;
the series of transversely extending cuts defining first and second adhesive free areas, with the first adhesive free area defining a leading edge of a first area of strips and the second adhesive free area defining a leading edge of a second area of strips; and
the first and second areas of strips are substantially equal in area.

14. A pressure sensitive laminate assembly as recited in claim 13, wherein the length of each of the first and second dimension is substantially equal.

15. A pressure sensitive laminate assembly as recited in claim 13, wherein the first width dimension is about 1″.

16. A pressure sensitive laminate assembly as recited in claim 13, wherein the second width dimension is about 0.5″.

17. A pressure sensitive laminate assembly as recited in claim 13, wherein the pressure sensitive adhesive is selected from a group including permanent, removable and repositionable adhesive.

18. A pressure sensitive laminate assembly as recited in claim 13, wherein the first and second adhesive free areas is about 0.25″ wide.

19. A pressures sensitive laminate assembly as recited in claim 13, wherein the adhesive free areas are created through pattern coating.

20. A pressure sensitive laminate assembly as recited in claim 13, wherein the adhesive free zones are created through adhesive deadening.
